(19) United States
(12) Patent Application Publication
(10) Pub. No.: US 2002/0122473 A1
(43) Pub. Date: Sep. 5, 2002

(54) Method and device for the processing of interference in signals received by an array of sensors

(75) Inventors: Valery Leblond, Valence (FR); Alain Renard, Chabeuil (FR)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: THALES, PARIS (FR)

(21) Appl. No.: 10/023,943

(22) Filed: Dec. 21, 2001

(30) Foreign Application Priority Data
Dec. 22, 2000 (FR) 00 16874

(51) Int. Cl. H04K 1/00; H04B 1/69

(52) U.S. Cl. 375/148; 375/346

(57) ABSTRACT

A method to eliminate interference occupying at least one part of the spectrum of one or more signals received by a network of N sensors comprises at least the following steps: subdividing each sample xᵢ of signals into K frequency bands, weighting the samples xᵢₖ obtained by subdivision, combining the different weighted coefficients Wᵢₖ.Xᵢₖ by given frequency band index k in order to obtain signals Sₖ corresponding to

$${\sum }_{i = 1}^{N} {w}_{ik} \cdot {x}_{ik} ,$$

and then carrying out the combination of the signals sₖ for the totality of the bands K.

Application to a satellite signal received by a GPS receiver.

### BACKGROUND OF THE INVENTION

1. Field of the Invention

The invention relates to a method and device for processing and eliminating the interference present in one or more signals received by a network of N sensors.

It can be applied to the elimination of deliberate or involuntary interference occupying all or part of the spectrum of satellite signals received by GPS (global positioning system) receivers.

The invention can be applied to improving interference processing methods in different signal-processing systems.

It can also be used to get rid of deliberate or involuntary interference in signals received by standard receivers.

2. Description of the Prior Art

Systems for anti-interference processing in antenna networks presently use methods in which the entire band of the GPS signal received as input data is taken into account.

In most of these methods, an apparent antenna is formed by the weighted combination of the signals coming from elementary sensors. What is done actually is to use a network of spatially separated sensors and, by a “constructive” or “destructive” combination, to highly attenuate the signal in all the directions identified as being occupied by one or more interference phenomena. Typically, these are standard principles of the CRPA (Controlled Radiation Pattern Antenna) implementing power inversion algorithms that are particularly well suited to useful noise signals whose level is lower than that of thermal noise, which is the case with GPS signals.

To determine the coefficients of combination mentioned here above, the CRPA algorithm uses the principle described here below with reference to FIG. 1.

The analog radioelectrical GPS signals, sᵢ, are received by the N sensors Ci of an antenna array. These signals si have a spectrum constituted by a 20 MHz band centered on the frequency L₁ =1.575 GHz (carrier frequency) and the frequency L₂ =1.273 GHz, these two carrier frequencies being known in the GPS field. They are transmitted to a set 1 of transposition circuits, to be transposed to an intermediate frequency Fi lower than the carrier frequency L₁ (or L₂). The frequency transposition is achieved by methods known to those skilled in the art, such as the methods described in the patent FR 2.742.612 by the present applicant for example. These signals thus taken to an intermediate frequency may be filtered. All the processing operations are performed by means of an analog process known to those skilled in the art. The filtered signals are then digitized by means of an ADC (an analog-digital converter) 2 that works at a chosen sampling frequency Fe to comply with the Shannon theorem. The ADC generates digital samples that contain GPS signals at a sampling frequency rate Fe and throughout the band of the useful signal, and are applied to a computation unit 3 and to a processing block 4.

The computation unit 3 uses a CRPA type algorithm and a power inversion computation to identify the directions in which interference sources are present. This unit 3 determines the different weighting coefficients wᵢ to be applied to the digital samples.

The weighting coefficients wᵢ are applied at input of the processing block 4 to the samples xᵢ coming directly from the ADC 2, the unit 4 being adapted to making the interference sources disappear in the reconstituted samples, for example by combination of the weighted samples.

The algorithm used to determine the weighting coefficients to be applied to the samples is especially well suited to signals known as narrowband signals, namely continuous wave (CW) type signals or signals with low frequency spread, typically for signals having a frequency_{width} to center_{frequency} ratio that is smaller than unity. When interference comes into play on a wide frequency band, for example on the entire 20 MHz band in the case of the GPS P-code signal present in the L₂ band or again the C/A code present in the L₁ band, the interferences are less well eliminated by the power inversion algorithm. Or it is more likely that the number of degrees of freedom available, hence the number of interference phenomena that the receiver has to withstand, are thereby reduced.

Furthermore, in the case of mobile carriers (GPS type receivers or stations comprising GPS receivers) and/or for mobile interferences in space, the estimation of the power and the combination to be made is more noise-affected. It is therefore less precise instantaneously and may result in phase leaps in the reconstituted GPS signal that will substantially disturb its nominal operation. In one of the methods used to overcome this problem, a smoothing stratagem is integrated into the processing algorithm. This is done, for example, by the addition of fictitious noise in order to reduce the resultant noise on the weighting coefficients and, therefore, on the phase of the resultant signal. Such stratagems may, however, reduce the sensitivity of the anti-disturbance system, namely the level of minimum reference from which the power reversal algorithm will “perceive” and process the interference. The addition of fictitious noise raises the general floor above which the algorithm “perceives” the interference and above which the “minor” interference is not seen.

### SUMMARY OF THE INVENTION

The object of the invention relates to a signal-processing method used to eliminate interference in a signal received by a network of N sensors, for example a satellite signal received by a GPS receiver.

The object of the invention relates to a method to eliminate interference occupying at least one part of the spectrum of one or more signals received by a network of N sensors, the method comprising at least the following steps:

subdividing each sample xᵢ of signals into K frequency bands,

weighting the samples Xᵢₖ obtained by subdivision, with weighting coefficients wᵢₖ determined by power inversion processing,

combining the different weighted coefficients Wᵢₖ·Xᵢₖ by given frequency band index k to obtain signals Sₖ corresponding to

$${\sum }_{i = 1}^{N} {w}_{ik} \cdot {x}_{ik} ,$$

and then carrying out the combination of the signals Sₖ for the totality of the bands K.

The power inversion processing is, for example, of the CRPA type.

The invention also relates to a method to eliminate interferences occupying a part of the spectrum of a signal received by a network comprising N sensors, wherein the method comprises at least the following steps:

digitizing the signals si received by the sensors in N digital samples xᵢ,

transmitting the xᵢ digital samples to K filters Gₖ in order to subdivide each sample xᵢ into K frequency bands,

applying the xᵢₖ samples obtained by subdivision to:

a computation unit adapted to determining the weighting coefficients wᵢₖ, by power inversion processing,

a processing block adapted to:

combining the different weighted coefficients Wᵢₖ.Xᵢₖ for a given filter index k in order to obtain signals sₖ corresponding to

$${\sum }_{i = 1}^{N} {w}_{ik} \cdot {x}_{ik} .$$

combining the signals Sₖ in order to obtain a signal S′ that is totally or mostly free of interferences.

The object of the invention also relates to a device to eliminate the interferences in one or more signals si received by an array of N sensors comprising at least one set of means adapted to subdividing each sample xᵢ of signals into K frequency bands, weighting the samples xᵢₖ obtained by subdivision, combining the different weighted coefficients wᵢₖ·xᵢₖ by given frequency band index k to obtain signals Sₖ corresponding to

$${\sum }_{i = 1}^{N} {w}_{ik} \cdot {x}_{ik} ,$$

combining the signals Sₖ for the totality of the bands K.

The power inversion processing is, for example, of the CRPA type.

According to one embodiment, the device comprises at least:

one signal reception chain comprising circuits for the frequency transposition of the frequency of the initial signal to an intermediate frequency and an ADC to convert the signal S into N digitized samples,

a device adapted to subdividing each digitized signal xᵢ, into K frequency bands, in order to give N*K samples xᵢₖ,

a computation unit receiving the N*K samples and suited to determining weighting coefficients wᵢₖ, by power inversion processing,

a processing block receiving the weighting coefficients wᵢₖ and the samples xᵢₖ, said block being suited to the application of the weighting coefficients to the different samples, carrying out the combination firstly for a given index k of the xᵢₖ weighted samples with k of varying from 1 to K and secondly the K signals Sₖ with k varying from 1 to K, in order to obtain a signal S′.

The method and the device according to the invention are applied for example to eliminating the interferences in the signals sent by a satellite and received by a GPS receiver or again by a spread-spectrum positioning system or again a spread-spectrum navigation and communications system.

In particular, the invention offers the following advantages:

it very substantially strengthens the capacities of resistance to disturbing phenomena (deliberate or involuntary interference),

based on the principle of “network” processing to carry out “spatial” elimination, the invention is released from the need to carry out the classically used “narrowband” approximations,

it brings less noise into the narrowband for adaptive processing, thus tending to increase the sensitivity of the algorithm used,

by the addition of a Kalman filtering:

it absorbs the processing defects related to the dynamics of the carriers and the disturbing phenomena, and

gives an adaptive process for the correction of defects liable to be introduced by the hardware structure, the changes in the capacities of the components as a function of thermal phenomena for example.

### BRIEF DESCRIPTION OF THE DRAWINGS

Other features and advantages of the invention shall appear from the following the detailed description made with reference to the appended drawings, of which:

FIG. 1 shows an exemplary prior art GPS receiver,

FIG. 2 gives a diagrammatic view of the first implementation of the invention

FIG. 3 shows a second implementation of the invention integrating a Kalman filter.

### MORE DETAILED DESCRIPTION

In order to understand the object of the invention more clearly, the following description is given by way of an illustration that in no way restricts the scope of the invention for the processing of interference in signals received by GPS receivers.

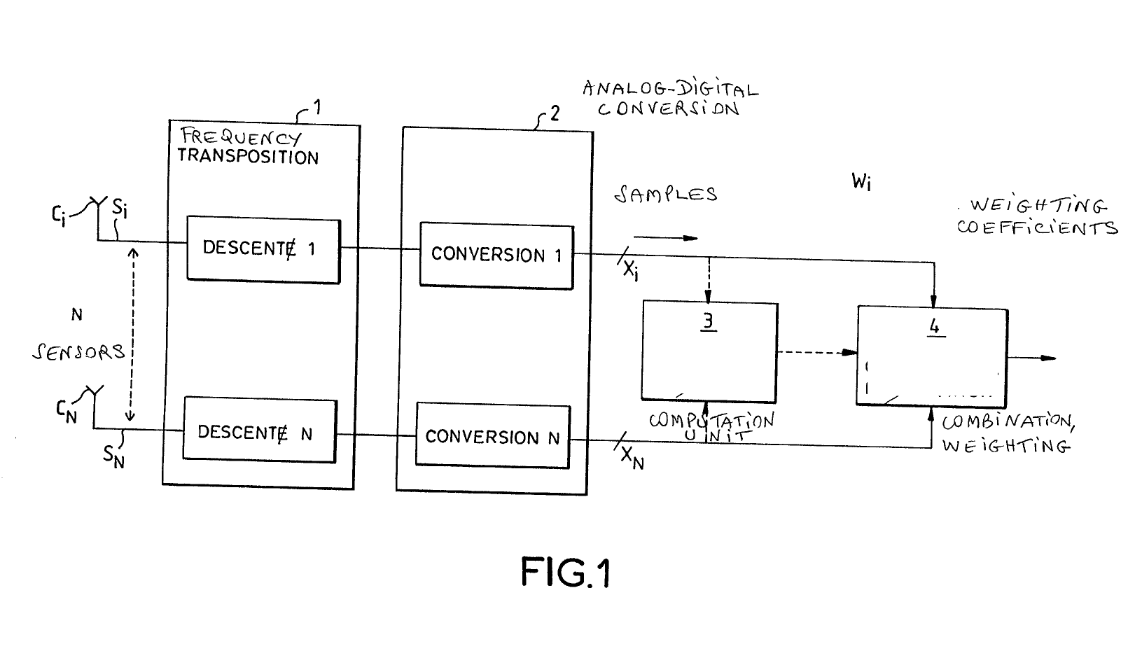

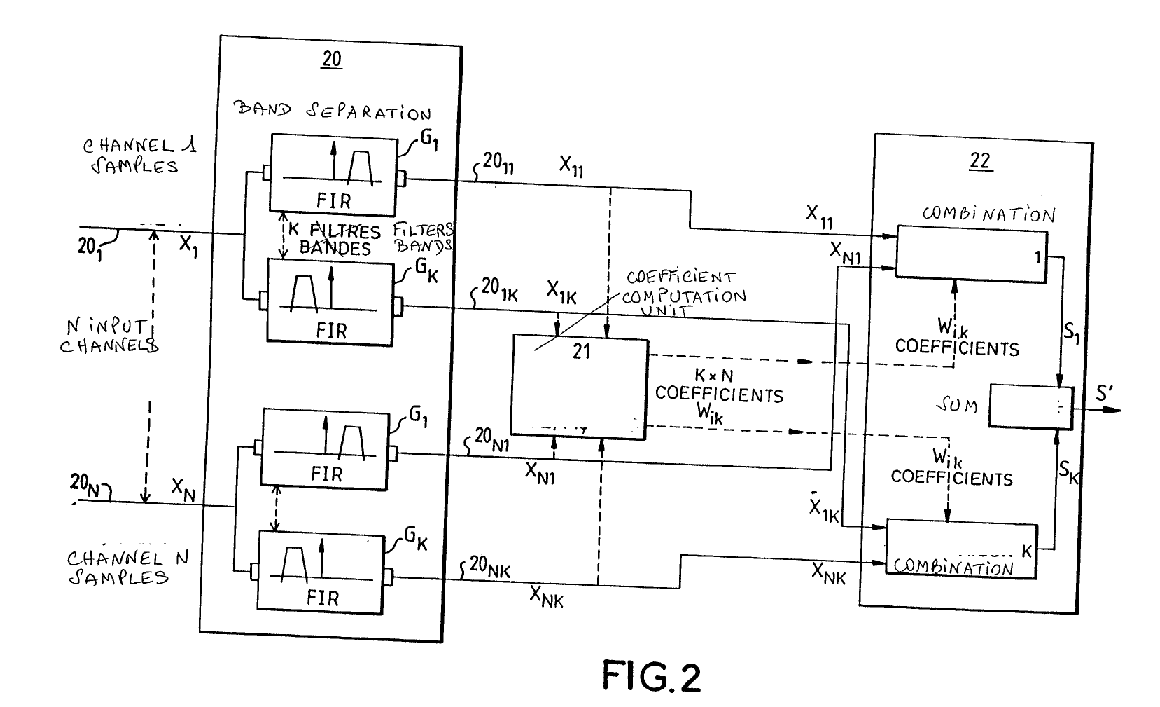

In a manner similar to that of FIG. 1, the device has an array of N sensors Ci, a frequency transposition block and an analog-digital converter not shown in FIG. 2 for reasons of simplification.

The N samples coming from the ADC 2 (FIG. 1) are applied to a device 20 adapted to carrying out a frequency subdivision. The frequency subdivision is performed by using a set of K finite impulse response (FIR) digital filters. The device 20 is provided with N input channels 20ᵢ corresponding to the N samples xᵢ, i being an index designating a sample, and N*K output channels 20ᵢₖ, with k being the index corresponding to the filter used. A sample xᵢ is applied to the K filters Gₖ so as to obtain K the digital signals designated by Xᵢₖ, corresponding to K bands narrower than the initial band of the signal.

The characteristics of each and/or of all of the K filters G₁ to G_{K} are chosen so that the sum of the frequency band thus obtained for each sample xᵢₖ, reconstitutes the total useful band fully or as fully as possible. Each sample has a 20 MHz useful band corresponding to the useful band of the GPS signal received on the sensor Ci.

The band separation process is achieved preferably by digital means. This provides for a precise adjustment of the coefficients of the different filters in order to obtain distortion-free reconstitution of the total band.

The samples xᵢₖ thus obtained are applied firstly to a computation unit 21 and secondly to a processing block 22.

The computation unit 21 is programmed to carry out a CRPA type power inversion processing and compute the dedicated weighting coefficients wᵢₖ, band by band for the N*K samples. At the end of this computation, the method is in possession of K sets of weighting coefficients (N*K coefficients), to be applied to the different samples Xᵢₖ for example at input of the processing block 22. The weighting coefficients thus obtained are better suited to the elimination of the K potential interference bands.

The processing block 22 is adapted to combining the weighted samples wᵢₖ·xᵢₖ. The combination step is carried out for example by initially combining the different weighted samples for a given filter index k, in achieving a variation in index i from 1 to N, to obtain several signals Sₖ corresponding to

$${\sum }_{i = 1}^{N} {w}_{ik} \cdot {x}_{ik} .$$

In a second stage of this combination step, the signals Sₖ,

$${\sum }_{k = 1}^{K} {s}_{k}$$

are summed. The sum represents the reconstituted signal S′exempt or practically exempt from interference. The different computations are made by means of appropriate processing algorithms, and the components used could be of the FPGA or ASIC type.

Advantageously, this embodiment is used to overcome the “narrowband” limitation of the commonly used CRPA type adaptive methods of power inversion. Furthermore, by working on narrower bands then the initial signal band, the noise level is reduced to the processing level. Hence, for equivalent filtering processing, the sensitivity of the method is increased.

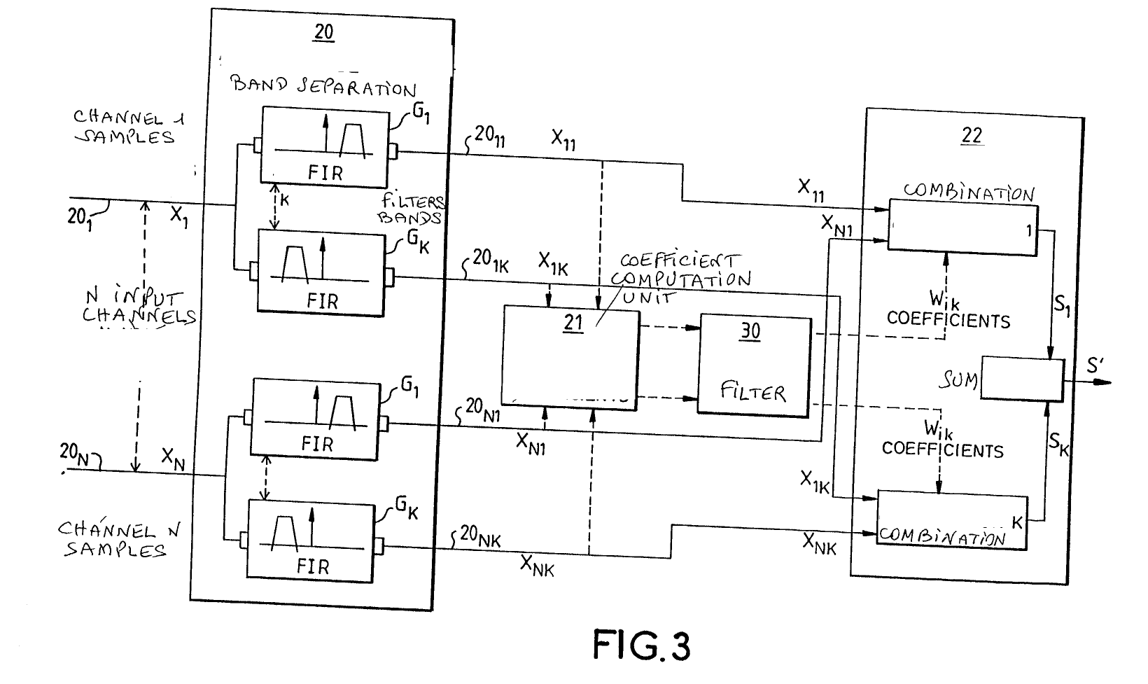

FIG. 3 describes a second exemplary embodiment of the invention where the similar elements taken up in FIG. 2 relate to the same references. This embodiment is especially well suited in the case of mobile interference or mobile carriers.

In this example, the N*K weighting coefficients obtained by the power inversion computation are applied in a dynamic filtering step, by using for example a Kalman type filter 30. The filter made by means of an adapted device, has the function especially of separating the directional coefficients from the N*K coefficients (with a high dynamic range or related to the dynamic range of the disturbing phenomena) from the distortions related to the reception lines (continuous components on a distant horizon).

The dynamic range of the disturbing phenomenon is, for example, spectral, of the spectral sweep jamming type or again it may be an loaded type of geographical jammer. Again it may be disturbance from jammer switching or it may be a pulsed jammer type of temporal disturbance.

By adapting the Kalman filter to the different dynamic ranges, it is possible to resorb a part of the problems of dynamic range related to the tracking of interference during a movement, for example a severe operational constraint while, at the same time, correcting the receiver distortions, such as HF defects in particular: phase matching, amplitude etc, which limit the performance of the elimination.

Classically, in a Kalman filter, the matching is done by the judicious choice of the <<model noise >>. This noise is generally fixed and is defined at the designing stage but may also be defined as a function of criteria that do not arise out of the measurements found.

The filtered coefficients are then sent to the processing block 22 to combine the different weighted samples. This operation is carried out by frequency band, as described with reference to FIG. 2.

The total signal after processing is then reconstituted by summation, for example before it is used according to the known prior art methods as a signal obtained by a standard CRPA operation.

Without departing from the framework of the invention, the method can be applied in the field of inertia/GPS hybridization and also in any field used to separate the dynamic values included in the weighted coefficients.

The method can also be applied to all the signals of a spread-spectrum positioning system such as the GPS, the GLONASS (Global Orbiting Navigation Satellite System), Galileo or any other spread-spectrum navigation and communications system.

What is claimed is:

1. A method to eliminate interference occupying at least one part of the spectrum of one or more signals received by a network of N sensors, the method comprising at least the following steps:
subdividing each sample xᵢ of signals into K frequency bands,
weighting the samples Xᵢₖ obtained by subdivision, with weighting coefficients wᵢₖ determined by power inversion processing,
combining the different weighted coefficients wᵢₖ.xᵢₖ by given frequency band index k to obtain signals sₖ corresponding to
$${\sum }_{i = 1}^{N} {w}_{ik} \cdot {x}_{ik} ,$$
and then carrying out the combination of the signals sₖ for the totality of the bands K.

2. A method according to claim 1 wherein the power inversion processing is, for example, of the CRPA type.

3. A method to eliminate the interferences occupying a part of the spectrum of a signal received by a network comprising N sensors, wherein the method comprises at least the following steps:
digitizing the signals sᵢ received by the sensors in N digital samples xᵢ,
transmitting the xᵢ digital samples to K filters Gₖ in order to subdivide each sample xᵢ into K frequency bands,
applying the xᵢₖ samples obtained by subdivision to:
a computation unit adapted to determining the weighting coefficients wᵢₖ, by power inversion processing,
a processing block adapted to:
combining the different weighted coefficients wᵢₖ.xᵢₖ for a given filter index k in order to obtain signals sₖ corresponding to
$${\sum }_{i = 1}^{N} {w}_{ik} \cdot {x}_{ik} ,$$
combining the signals sₖ in order to obtain a signal S′ that is totally or mostly free of interference.

4. A method according to claim 3 wherein the subdivision step uses an FIR type filter.

5. A method according to one of the claims 1 to 4, comprising a step for filtering the dynamic range of the coefficients coming from the computation unit.

6. A use of the method according to one of the claims 1 to 5 or of the device according to claims 7 to 10 for the elimination of interference in a signal sent by a satellite and received by a GPS receiver.

7. A device to eliminate interferences in one or more signals sᵢ received by a network of N sensors comprising at least one set of means adapted to subdividing each sample xᵢ of signals into K frequency bands, weighting the samples xᵢₖ obtained by subdivision with weighting coefficients obtained by power inversion processing, combining the different weighted coefficients wᵢₖ.xᵢₖ by given frequency band index k in order to obtain signals sₖ corresponding to
$${\sum }_{i = 1}^{N} {w}_{ik} \cdot {x}_{ik} ,$$
combining the signals sₖ for the totality of the bands K.

8. A device according to claim 7 wherein the power inversion processing is a CRPA type processing.

9. A device according to claim 7 comprising at least:
one signal reception chain comprising circuits for the frequency transposition of the frequency of the initial signal to an intermediate signal and an ADC to convert the signal S into N digitized samples,
a device adapted to subdividing each digitized signal xᵢ, into K frequency bands, in order to give N*K samples xᵢₖ,
a computation unit receiving the N*K samples and suited to determining weighting coefficients wᵢₖ, by power inversion processing,
a processing block receiving the weighting coefficients wᵢₖ and the samples xᵢₖ, said block being suited to the application of the weighting coefficients to the different samples, carrying out the combination firstly for a given index k of the xᵢₖ weighted samples with k of varying from 1 to K and secondly the K signals sₖ with k varying from 1 to K, in order to obtain a signal S′.

10. A device according to one of the claims 7 or 9, wherein the means for subdividing the samples into K frequency bands is formed by a set of K FIR type filters.

11. A device according to one of the claims 7 to 10, comprising a device to filter the dynamic range of at least one of the weighting coefficients such as a Kalman filter.

12. An application of the device according to one of the claims 7 to 10 to eliminate the interferences in the signals sent by a satellite and received by a GPS receiver or again by a spread-spectrum positioning system or again a spread-spectrum navigation and communications system.
